(19) United States
(12) Patent Application Publication
(10) Pub. No.: US 2025/0214405 A1
(43) Pub. Date: Jul. 3, 2025

(54) Soft car cover Structure

(71) Applicant: Yunxia Shao, Hangzhou (CN)

(72) Inventors: Shaoyong Zheng, Hangzhou (CN); Yunxia Shao, Hangzhou (CN)

(21) Appl. No.: 18/656,968

(22) Filed: May 7, 2024

(30) Foreign Application Priority Data
Dec. 29, 2023 (CN) 202323667798.9

(51) Int. Cl. B60J 7/12

(52) U.S. Cl. CPC B60J 7/12

(57) ABSTRACT

The utility model discloses a soft car cover structure comprising a front rail, a joint group, a rear rail, a side rail, a waterproof tape, a first support bar, a third support bar, and a fourth support bar, wherein the first support bar, the third support bar, and the fourth support bar are connected to the side rail, the front rail, the rear rail, the first support bar, the third support bar, and the fourth support bar form a transverse support structure, and the waterproof tape is connected to a longitudinal support structure.

### CROSS-REFERENCE TO RELATED APPLICATIONS

The application claims priority of Chinese patent application CN202323667798.9, filed on Dec. 29, 2023, which is incorporated herein by reference in its entireties.

### TECHNICAL FIELD

The utility model belongs to the field of automobile accessories and specifically relates to a soft car cover structure.

### TECHNICAL BACKGROUND

A pickup truck is one of the most common automobiles in life. With the advantages of comfort, stability, and also transportation of goods, pickup trucks are an indispensable part of the automobile market. The carrier, as the most important feature of the pickup truck, is more often used for transporting goods.

However, most of the existing pickup truck carriers are open structure, which can't protect the goods properly when encountering rainy or snowy days, so many pickup trucks start to be equipped with separate car cover, but the structure of the car cover required by different vehicle models is different, and the front part of the car cover is usually not open, While the rear part needs to be opened frequently, which makes the locking structure of the front and rear different, and the locking structure of the rear should be convenient for both open/close, and due to the fact that the rear locking structure needs to be opened/closed frequently, it is relatively easy to be damaged, so it is necessary to minimize the replacement cost.

The existing soft car cover structures are relatively simple, they are not only poor in applicability, but also use the same locking structure, which makes it inconvenient to open. In addition, the waterproofing performance is not satisfactory.

### UTILITY MODEL DESCRIPTION

In order to overcome the deficiencies of the prior art, the present utility model aims to provide a soft car cover structure by changing the structure of the car cover to make the car cover adaptable to different vehicle models, thereby solving the above problems.

In order to solve the above problems of the prior art, the technical solution adopted in the present utility model is as follows:

A soft car cover structure characterized in that: it comprises a front rail, a joint group, a rear rail, a side rail, a waterproof tape, a first support bar, a third support bar, and a fourth support bar, the first support bar, the third support bar, and the fourth support bar are all connected to the side rails.

The front rail, the rear rail, the first support bar, the third support bar and the fourth support bar form a transverse support structure;

The side rails and the joint group form a longitudinal support structure, the waterproof tapes are connected to the longitudinal support structure, and two adjacent side rails are connected to each other by the joint group, and the longitudinal support structure and the transverse support structure form a car cover frame connected to a piece of tarpaulin;

The first support bar comprises a support bar body, a support bar T-bar and a support bar slider, the support bar body is connected to the side rails, the underside of the support bar body is a support bar support surface, the support bar slider is connected to the support bare body, the support bar slider is provided with a slider protrusion lock and an intermediate sliding groove, the a slider protrusion lock is used to catch the T-shape support bar, when the long bar is caught with the slider protrusion lock, the support bar T-bar is located between the slider protrusion lock and the support bar support surface, the support bar T-bar includes a cylindrical head, the cylindrical head extending into the intermediate sliding groove, the cylindrical head is used, which has a better stability compared to the existing spherical head structure.

A transverse support structure is formed by a front rail, a rear rail, and a plurality of support bars (here, the support bars include the first support bar, the second support bar, the third support bar, and the fourth support bar, which may be one or more of them), which improve the force performance of the whole car cover, and a longitudinal support structure is used to connect with the transverse support structure to form the frame of the car cover, and a waterproof adhesive strip is connected with the longitudinal support structure to be able to provide a good waterproofing effect.

Furthermore, the soft car cover structure according to claim 1, characterized in that: the first support bar comprises a support bar slider insert and a support bar wrench, the support bar wrench is connected to the support bar T-bar, and the support bar slider insert is connected to the support bar slider, the support bar slider is connected to a support bar T-shaped bar, and the support bar T-shaped bar is connected to a support bar wrench, the soft car cover structure according to claim 2, characterized in that: the support bar T-bar further comprises a long bar which is an integral structure together with the cylindrical head, and the long bar is used to be pressed in under the slider protrusion lock to lock the long bar, the support bar slider includes a slider protrusion positioning part, and the cylindrical head extends into the middle sliding groove. The middle sliding groove is detachably connected to a support bar slider insertion block. The support bar slider is inserted into the support bar body, and the slider protrusion positioning part is used for engaging and limiting with the long bar. The support bar body includes a support bar support surface, which is used to cooperate with the support bar wrench for limiting. Multiple support bars can be provided, and the specific number can be adjusted according to the length of the car cover and the required strength. Among them, the structure of each support bar can be the same or not completely the same. The first support bar is connected to the support bar slider on the support bar, and then the support bar T-shaped bar is connected to the support bar slider. Next, the support bar wrench is connected to the support bar T-shaped bar, and finally, the car cover is locked and connected by using the support bar wrench. Specifically, the support bar slider is provided with a middle sliding groove, and the cylindrical head extends into the middle sliding groove. Locking is achieved by rotating the support bar wrench. The support bar slider is also provided with a slider positioning hole, and the screw fixes the support bar slider through the slider positioning hole.

Furthermore, the joint group comprises a large joint group, a medium joint group and a small joint group, or the joint group comprises a large joint group and a small joint group, the large joint group and the small joint group have a respective waterproof spacer, respectively, and further comprises a second support bar, the second support bar is interposed between the first support bar and the third support bar, the number of joint groups can be adjusted according to the frequency of folding of the car cover. Each joint group represents one side of the folded car cover, and the size of the joint groups can also be selected according to the need, and the size and structure of each joint group can be the same or different, the joint group comprises a left joint, an intermediate joint, a right joint, a first cavity and a second cavity, the left joint has a left joint protrusion, the intermediate joint has an intermediate joint protrusion and a first cavity, and the right joint has a second cavity, and the left joint protrusion uses a spring pin to connected to the first cavity, and the intermediate joint protrusion uses a spring pin to connected to the second cavity, and the spring pin does not have a notch. (Wherein the notch is a notch along the direction of the axis), the length of the intermediate joint protrusion is greater than that of the left joint protrusion, and the depth of the first cavity is less than that of the second cavity. The left joint protrusion, the first cavity, the intermediate joint protrusion, and the second cavity are all provided with pin holes for connecting the spring pins. The first cavity and the second cavity are correspondingly provided with openings, the left joint and the right joint are each provided with reinforcement bars. The spring pin is provided with a notch for expansion, the large the deformation of notch is larger, the larger the fixing force of the spring pin. The reinforcement bars are provided to increase the strength of the left joint and the right joint. The intermediate joint protrusion is on the front side of the intermediate joint.

Furthermore, it further comprises a first extruded spacer and a second extruded spacer, the first extruded spacer being used to be seated between the left connector protrusion and the first cavity, and the second extruded spacer being used to be seated between the intermediate joint protrusion and the second cavity, the joint group adopts the same direction rotation structure, in which one rotation center is in the intermediate structure and the other rotation center is in the left joint or the right joint, and the two rotation centers rotate in the same direction when rotating. As the soft car cover uses the structure of the car cover frame+tarpaulin, if the two rotation centers of the joint group rotate in the same direction, the tarpaulin will pile up toward the center or be stretched out to the two sides, which is easy to break the tarpaulin, but, such a problem can be easily avoided by the same direction rotation. The length of the intermediate joint protrusion is longer than that of the left joint protrusion, which can increase the space of the second cavity, so that when rotating and folding, there is enough space to prevent the tarpaulin from being pinched. However, due to the increase in the depth of the first cavity and the second cavity, the sealing effect of the joint group in the joints is greatly reduced, to improve the sealing effect, the first extrusion spacer and the second extrusion spacer can be added. The left joint and the right joint are each connected to the intermediate joint by the spring pin, and the greater the tension of the spring pin, the tighter the connection between the two. Add the reinforcement rubber to the left joint and the right joint improve the stress resistance of the left joint and the right joint.

Furthermore, the side rails are connected to the vehicle body by an anti-detachment assembly, the anti-detachment assembly comprises an upper hook, wherein the upper hook is attached to the side rail, and the upper hook has a bayonet; The anti-disengagement T-shaped bar passes through the lower hook. One end of the anti-disengagement T-shaped bar is equipped with a locking port matched a square head, and the other end of the anti-disengagement T-shaped bar is connected to an anti-disengagement plum-shaped nut, an anti-detachment T-bar, and a lower hook, the side rails are connected to the vehicle body by the anti-detachment hook assembly, because the car cover cannot be easily removed after connection, so as long as the stability of the connection between the side rails and the vehicle body can be ensured, it is fine. The original left and right clamping structure makes the side rails slide up and down on bumpy road surfaces, and the upper hook and the lower hook in this application cooperate to connect the side rails to the vehicle body in the longitudinal direction and hook them tightly, which effectively avoids the up and down sliding problem, and furthermore, by the bayonet to limit the square head, the car cover will not swing from side to side, but is good in connection stability.

Furthermore, the waterproof gasket comprises a left gasket, a middle gasket, and a right gasket, a waterproof surface is formed between the left gasket and the middle gasket, a waterproof surface is formed between the middle gasket and the right gasket, and the waterproof surface includes a concave surface and a convex surface, the joint groups must be rotated, the waterproof tape will have a breaking point here, so it is necessary to set a special waterproof spacer for the joint groups. The waterproofing spacer is divided into three parts like the joint group, and each waterproofing spacer corresponds to one joint, and when the joint group is rotated to a horizontal plane, the waterproofing spacers are closely adjacent to each other to form a waterproofing seal structure. In order to improve the sealing effect, a sealing surface is provided at the position where two sealing spacers are in contact. The two parts of the sealing surface can be formed as a convex surface and a concave surface which exactly match each other, or in other structures as needed.

Furthermore, the waterproof tape is provided at the lower side of the longitudinal support structure and is separated at the joint group. The waterproof tape is disposed between the car cover and the bucket to bridge the gap between the car cover and the compartment to improve the waterproofing effect. the fourth support bar comprises a intermediate bar, a slider, a T-bar, and a hook, the slider is connected to the intermediate bare, and it comprises a first slider slot and a second slider slot, both of which are connected to each other, the T-bar comprises a bar head and a long T-bar, the bar head extending through the first slider slot into the second slider slot, the hook connected to the long T-bar is used to snap onto the edge of the vehicle body, while the long T-bar is connected to a plum nut, the intermediate bar is provided with an intermediate bar support surface, and the bar head is sandwiched between the intermediate support surface and the slider protrusion.

The beneficial effect of the utility model is:

Through the reform on the soft car cover, the utility model can choose different support structures according to the size of the car cover, and the locking structures of the front and back are different, so as to apply to different use scenarios.

The utility model adopts a unique rotation structure, limited to avoid the problem of pinching and stretching the skin, which is specially adapted to the tarpaulin

The utility model adopts a unique waterproof structure with waterproof design specialized for the joint group, which can improve the waterproof effect.

### Description of the accompanying drawings

FIG. 1 is a structure diagram of the soft car cover in this utility model, I.

FIG. 2 is a drawing of a partial enlargement of part A of FIG. 1.

FIG. 3 is a drawing of partial enlargement of part B of FIG. 1.

FIG. 4 is a structure diagram of the soft car cover in this utility mode, II.

FIG. 5 is a drawing of a partial enlargement of part C of FIG. 4.

FIG. 6 is a structure diagram of the soft car cover in this utility model, III.

FIG. 7 is a drawing of partial enlargement of part D of FIG. 6.

FIG. 8 is a connection diagram of the support bar in this utility model, I.

FIG. 9 is a connection diagram of the support bar in this utility model, II.

FIG. 10 is a structure diagram of the soft car cover in this utility model, I.

FIG. 11 is a drawing of a partial enlargement of part E of FIG. 10.

FIG. 12 is a structure diagram of the soft car cover in this utility model; V

FIG. 13 is a drawing of partial enlargement of part F of FIG. 12.

FIG. 14 is a connection diagram of the support bar; III

FIG. 15 is a connection diagram of the support bar, IV

FIG. 16 is a connection diagram of the support bar, V

FIG. 17 is a structure diagram of the shaft system, I.

FIG. 18 is an exploded view of the shaft system.

FIG. 19 is a structure diagram of the shaft system, II.

FIG. 20 is a structure diagram of the soft car cover in this utility model, VI.

FIG. 21 is a drawing of partial enlargement of part G of FIG. 20.

In the figure: 1-front rail; 2-large joint group; 3-intermediate joint group; 31-left joint; 3101-left joint protrusion; 3102-reinforcement rubber 3103-pin hole; 32-intermediate joint; 3201-intermediate joint protrusion; 3203-openings; 33-right joint; 34-spring pin; 3401-notch; 35-first extruded spacer; 36-second extruded spacer; 37-first cavity; 38-second cavity; 4-small joint group; 5-back rail; 6-side rail; 7-first support bar; 71-support bar T-bar; 7101-cylindrical head; 7102-long bar; 72-support bar slider insert; 73-support bar slider; 7301-slider protrusion lock; 7302-intermediate sliding groove; 7304-slider positioning hole; 74-support bar wrench; 75-support bar body; 7501-support bar support surface; 8-second support bar; 9-third support bar; 10-fourth support bar; 102-plum nut; 103-hook; 104-T-bar; 10401-bar head; 10402-long T-bar; 105-slider; 10501-slider protrusion; 10502-first slider slot; 10503-second slider slot; 106-Intermediate bar; 10601-Intermediate bar support surface; 11-Waterproof tape; 12-Waterproof spacer; 121-Left spacer; 12101-Convex surface; 122-Intermediate spacer; 12201-Concave surface; 123-Right spacer; 13-Anti-detachment assembly; 131-Upper hook; 13101-Bayonet; 132-Anti-detachment T-bar; 13201-Square head; 133-anti-detachment plum nut; 134-lower hook

### SPECIFIC IMPLEMENTATION EMBODIMENT

The utility model will be further described below in connection with the accompanying drawings and the markings on the drawings.

For a clearer understanding of the above objects, features and advantages of the present invention, the present invention will be described in detail below in connection with the accompanying drawings and specific embodiments. It should be noted that the embodiments of the present application and the features of the embodiments may be combined without conflict.

The terms “first”, “second”, “third” and the like are used only to differentiate the descriptions and are not to be understood as indicating or implying relative importance.

It should also be noted that in the description of the present invention, unless otherwise expressly specified and limited, the terms “establish”, “install”, “linked”, “connected” are to be understood in a broad sense, such as a fixed connection, a removable connection or a connection in one piece; a mechanical connection or an electrical connection; a direct connection or an indirect connection through an intermediate medium; or a connection within two elements. Those skilled in the art will understand the specific meanings of the above terms in the present invention in particular cases.

Specific embodiments of the present utility model are described in detail below in conjunction with the accompanying drawings. It should be understood that the specific embodiments described herein are for illustration and explanation of the present invention only and are not intended to limit the present invention.

### Embodiment 1

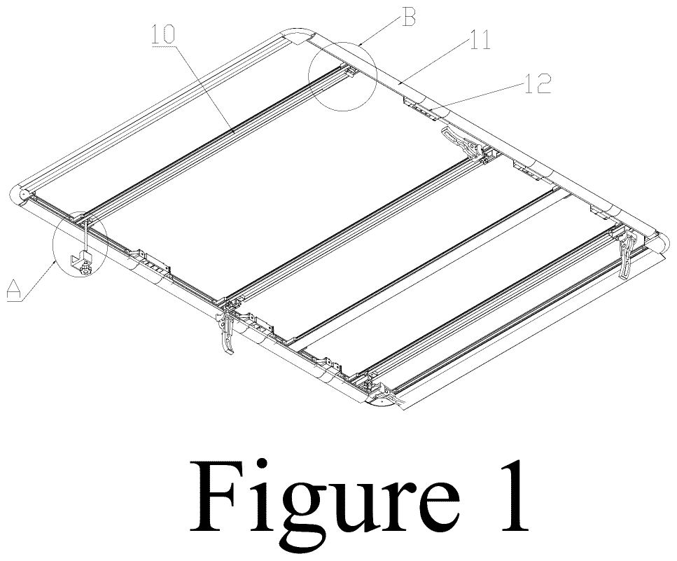

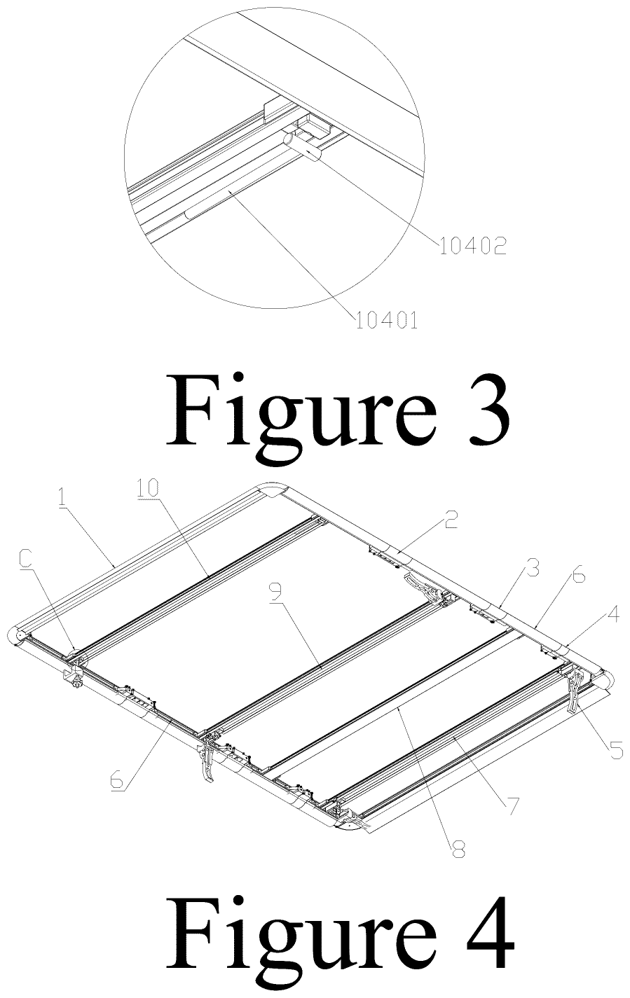

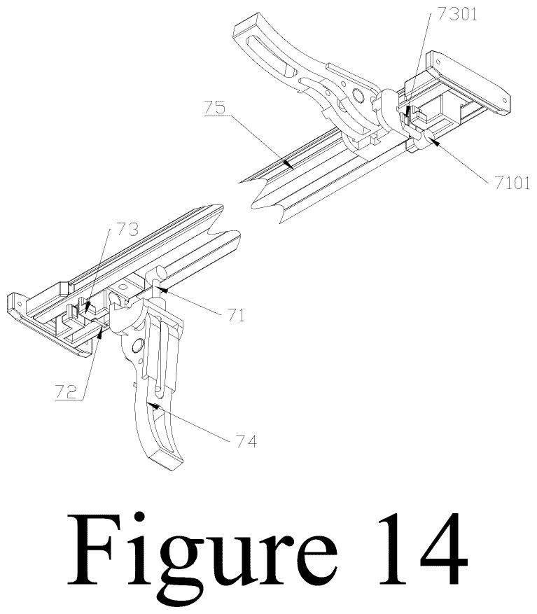

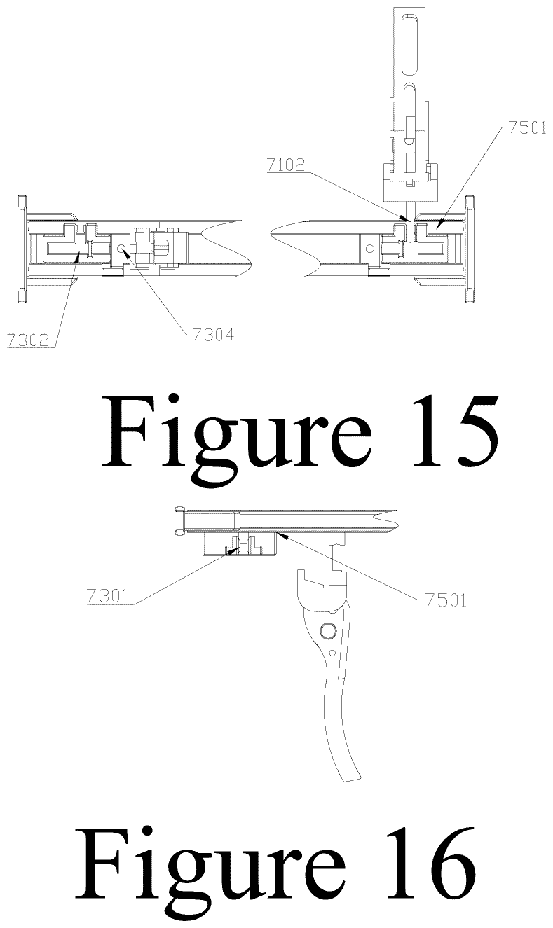

As shown in FIGS. 1, 4, 14-16, a soft car cover structure characterized in that: it comprises a front rail (1), a joint group, a rear rail (5), a side rail (6), a waterproof tape (11), a first support bar (7), a third support bar (9), and a fourth support bar (10), the first support bar (7), the third support bar (9), and the fourth support bar (10) are all connected to the side rails (6).

The front rail (1), the rear rail (5), the first support bar (7), the third support bar (9) and the fourth support bar (10) form a transverse support structure;

The side rails (6) and the joint group form a longitudinal support structure, the waterproof tapes (11) are connected to the longitudinal support structure, and two adjacent side rails (6) are connected to each other by the joint group, and the longitudinal support structure and the transverse support structure form a car cover frame connected to a piece of tarpaulin;

The first support bar (7) comprises a support bar body (75), a support bar T-bar (71) and a support bar slider (73), the support bar body (75) is connected to the side rails (6), the underside of the support bar body (75) is a support bar support surface (7501), the support bar slider (73) is connected to the support bare body (75), the support bar slider (73) is provided with a slider protrusion lock (7301) and an intermediate sliding groove (7302), the a slider protrusion lock (7301) is used to catch the T-shape support bar (71), when the long bar (7102) is caught with the slider protrusion lock (7301), the support bar T-bar (71) is located between the slider protrusion lock (7301) and the support bar support surface (7501), the support bar T-bar (71) includes a cylindrical head (7101),the cylindrical head (7101) extending into the intermediate sliding groove (7302).

By forming a transversal support structure with the front rail (1), the rear rail (5) and a plurality of support bars, the entire car cover is made to have a better stress performance, and the longitudinal support structure is used to connect with the transversal support structure to form a frame of the car cover, and the waterproof tape (11) is connected with the longitudinal support structure, which can provide a good waterproofing effect.

By providing the slider protrusion lock (7301), the support bar T-bar (71) can be snapped into the slider protrusion lock (7301), which facilitates the restriction of the support bar T-bar (71).

### Embodiment 2

Based on embodiment 1, the first support bar (7), the second support bar (8) and the fourth support bar (10), the first support bar (7), the second support bar (8) and the fourth support bar (10) are connected to side rails (6), the first support bar (7) comprises a support bar slider insert (72) and a support bar wrench (74), the support bar wrench (74) is connected to the support bar T-bar (71), and the support bar slider insert (72) is connected to the support bar slider (73).

The support bar body (75) is connected to a support bar slider (73), the support bar slider (73) is connected to a support bar T-bar (71), and the support bar T-bar (71) is connected to a support bar wrench (74).

The support bar T-bar (71) further comprises a long bar (7102) which is an integral structure together with the cylindrical head (7101), and the long bar (7102) is used to be pressed in under the slider protrusion lock (7301) to lock the long bar (7102), the support bar slider (73) includes a slider protrusion lock (7301), the cylindrical head (7101) extending into an intermediate sliding groove (7302), the intermediate sliding groove (7302) being detachably connected to a support bar slider insert (72).

The support bar slider (73) snaps into a support bar body (75).

The slider protrusion lock (7301) snap limit is used to snap into the long bar (7102).

The support bar body (75) includes a support bar support surface (7501), wherein the support bar support surface (7501) is used to fit a support bar wrench (74) in a limited position.

A plurality of support bars may be provided, and the specific number may be adjusted according to the length of the car cover and the required strength, wherein the structure of each support bar may be the same or not identical. For example, the first support bar (7) is connected to the support bar slider (73) on the support bar, then the support bar slider (73) is connected to the support bar T-bar (71), and then via the support bar T-bar (71) is connected to the support bar wrench (74), and finally the support bar wrench (74) is used to connect and lock the car cover. In particular, the support bar slider (73) is provided with an intermediate sliding groove (7302), the cylindrical head (7101) extends into the middle sliding groove (7302), and then the support bar wrench (74) is rotated to connect and lock the car cover. During locking, the support bar support surface (7501) is in contact with the vehicle body or the side rails (6).

The support bar wrench (74) can be rotated to a horizontal state, when the support bar wrench (74) rotates to the horizontal position, the T-shaped bar (71) engages with the protruding slide block clamp (7301).

The support bar slider (73) also has a slider positioning hole (7304) through which the screw secures and supports the support bar slider (73).

During installation, the support bar slider (73) is first snapped into the bar slot of the support bar, hen connect the support bar slider (73) to the support bar body (75) through screws.

### Embodiment 3

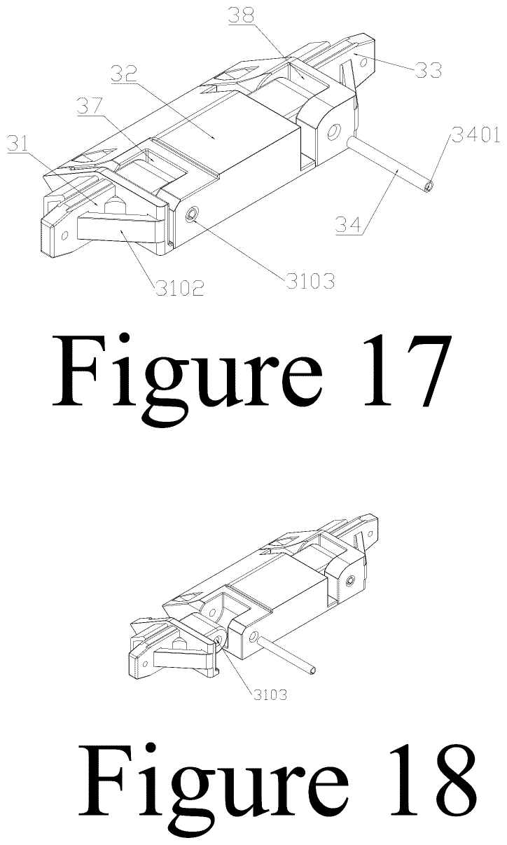

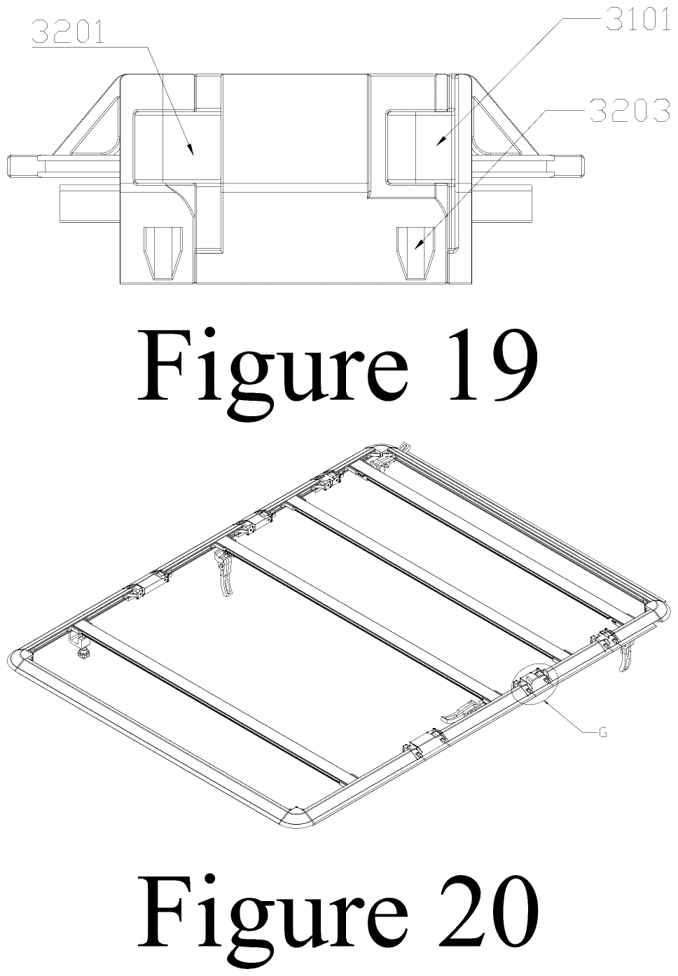

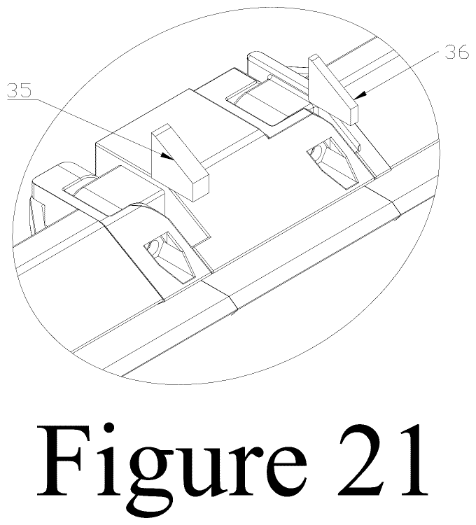

Based on embodiment 2, as shown in FIGS. 17-21, the joint group comprises a large joint group (2), a medium joint group (3) and a small joint group (4). Or the joint group comprises a large joint group (2) and a small joint group (4), the large joint group (2) and the small joint group (4) have a respective waterproof spacer (12), respectively, and further comprises a second support bar (8), the second support bar (8) is interposed between the first support bar (7) and the third support bar (9).

The number of joint groups can be adjusted according to the frequency of folding of the car cover. Each joint group represents one side of the folded car cover, and the size of the joint groups can also be selected according to the need, and the size and structure of each joint group can be the same or different.

The joint group comprises a left joint (31), an intermediate joint (32), a right joint (33), a first cavity (37) and a second cavity (38), the left joint (31) has a left joint protrusion (3101), the intermediate joint (32) has a intermediate joint protrusion (3201) and a first cavity (37), and the right joint (33) has a second cavity (38), and the left joint protrusion (3101) uses a spring pin (34) to connected to the first cavity (37), and the intermediate joint protrusion (3201) uses a spring pin (34) to connected to the second cavity (38), and the spring pin (34) does not have a notch (3401). (The gap 3401 here refers to a gap along the axial direction.)

The length of the intermediate joint protrusion (3201) is greater than that of the left joint protrusion (3101), and the depth of the first cavity (37) is less than that of the second cavity (38).

The left joint protrusion (3101), the first cavity (37), the middle joint protrusion (3201), and the second cavity (38) are all provided with insertion a connecting the spring pin (34) pin holes (3103) for The first cavity (37) and the second cavity (38) are respectively provided with openings (3203).

The left joint (31) and the right joint (33) are equipped with reinforcement ribs (3102) respectively.

The spring pin (34) is set with a notch (3401) for expansion, and the larger deformation of the notch (3401) will increase the fixing force of the spring pin (34). The reinforcement rib (3102) is designed to enhance the strength of the left joint (31) and the right joint (33). The middle joint protrusion (3201) is located on the front surface of the middle joint (32).

It further comprises a first extruded spacer (35) and a second extruded spacer (36), the first extruded spacer (35) being used to be seated between the left connector protrusion (3101) and the first cavity (37), and the second extruded spacer (36) being used to be seated between the intermediate joint protrusion (3201) and the second cavity (38).

The joint assembly adopts a unidirectional rotation structure, with one rotation center in the middle structure and the other rotation center in the left joint (31) or the right joint (33). When rotating, the two rotation centers rotate in the same direction. Since the soft car cover is a structure composed of a car cover frame and a waterproof leather, if the two rotation centers of the joint assembly adopt different directions, there may be problems such as the waterproof leather accumulating in the middle or stretching on both sides, which can easily tear the waterproof leather. However, unidirectional rotation can effectively avoid the above problems.

The length of the intermediate joint protrusion (3201) is longer than that of the left joint protrusion (3101), which can increase the space of the second cavity (38), so that when rotating and folding, there is enough space to prevent the tarpaulin from being pinched.

However, due to the increase in the depth of the first cavity (37) and the second cavity (38), the sealing effect of the joint group in the joints is greatly reduced, to improve the sealing effect, the first extrusion spacer (35) and the second extrusion spacer (36) can be added.

The left joint (31) and the right joint (33) are each connected separately through spring pin (34) and intermediate joint (32), and the greater the tension of the spring pin (34), the tighter the connection between the two.

Adding left joint (31) and right joint (33) with reinforcement (3102), enhancing the stress strength of left joint (31) and right joint (33).

### Embodiment 4

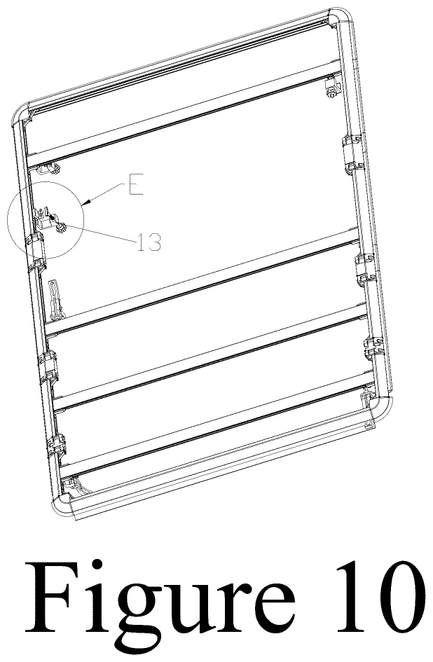

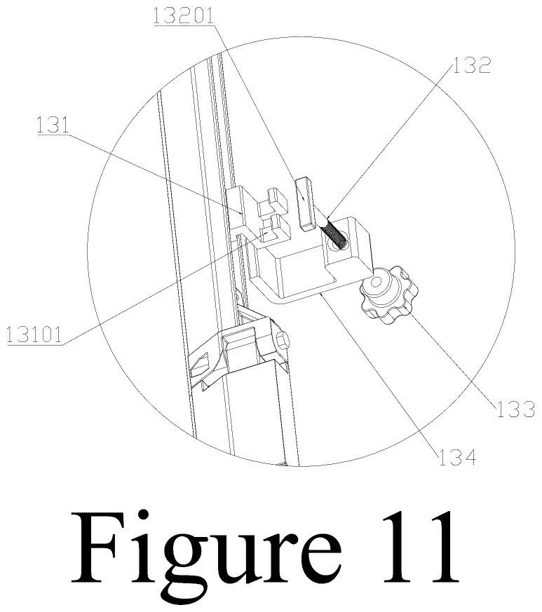

Based on embodiment 3, as shown in FIGS. 10-11, the side rails (6) are connected to the vehicle body by an anti-detachment assembly (13),the anti-detachment assembly (13) comprises an upper hook (131), an anti-detachment T-bar (132), and a lower hook (134), wherein the upper hook (131) is attached to the side rail (6), and the upper hook (131) has a bayonet (13101), the anti-disengagement T-shaped bar (132) passes through the lower hook (134). One end of the anti-disengagement T-shaped bar (132) is equipped with a locking port (13101) matched a square head (13201), and the other end of the anti-disengagement T-shaped bar (132) is connected to an anti-disengagement plum-shaped nut (133).

The side rail (6) is connected to the vehicle body through the anti-detachment hook assembly (13). Since the car cover is not easily removed after being connected, it is only necessary to ensure the stability of the connection between the side rail (6) and the vehicle body. The original left and right clamping structure causes the side rail (6) to slide up and down on bumpy roads. In this application, the upper hook (131) and the lower hook (134) cooperate to vertically connect and hook the side rail (6) to the vehicle body, effectively avoiding the problem of vertical sliding. In addition, by limiting the slot (13101) to the square head (13201), the car cover will not shake left or right, and the connection stability is good.

### Embodiment 5

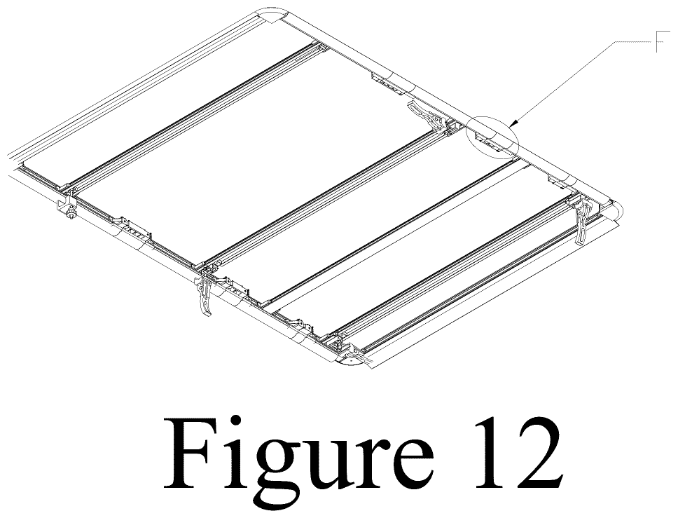

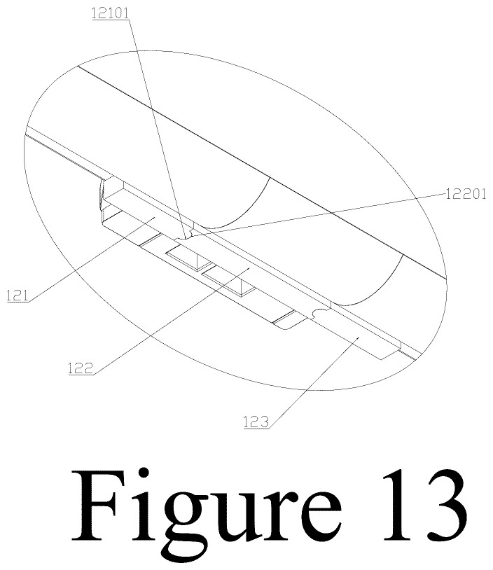

Based on embodiment 4, as shown in FIGS. 12-13, the waterproof gasket (12) comprises a left gasket (121), a middle gasket (122), and a right gasket (123), a waterproof surface is formed between the left gasket (121) and the middle gasket (122), a waterproof surface is formed between the middle gasket (122) and the right gasket (123), and the waterproof surface includes a concave surface (12201) and a convex surface (12101).

Since the joint assembly needs to rotate, there will be a discontinuity in the waterproof adhesive strip (11) at this position, so a special waterproof gasket (12) needs to be installed for the joint assembly. The waterproof gasket (12) is divided into three parts, just like the joint assembly, with each waterproof gasket (12) corresponding to one joint. When the joint assembly rotates to a horizontal position, the waterproof gaskets (12) are close to each other, forming a waterproof sealing structure. To improve the waterproof effect, a waterproof surface is provided at the contact position of two waterproof gaskets (12). The two parts of the waterproof surface can be designed as exactly matching convex surfaces (12101) and concave surfaces (12201). Alternatively, the waterproof surface can be designed into other structures according to needs.

### Embodiment 6

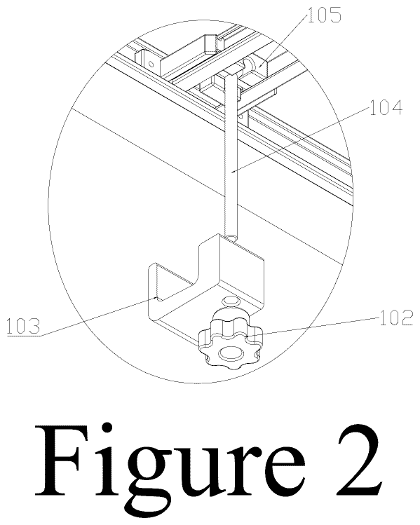

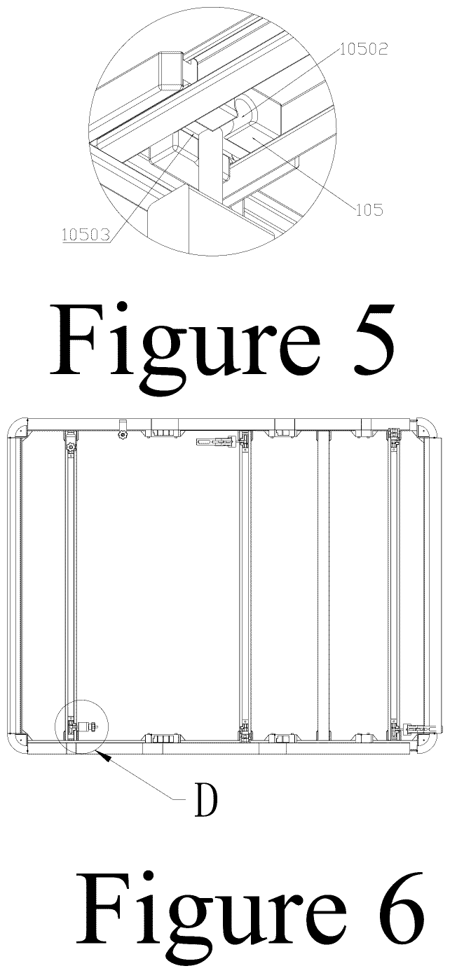

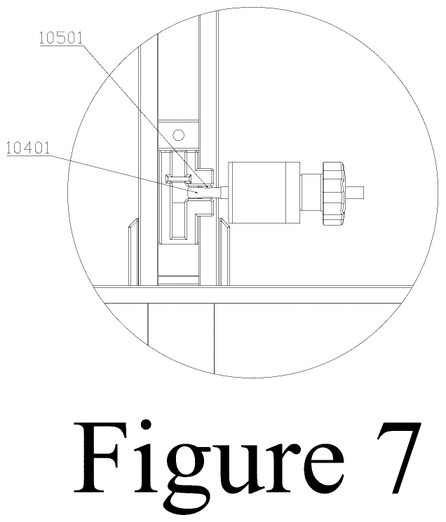

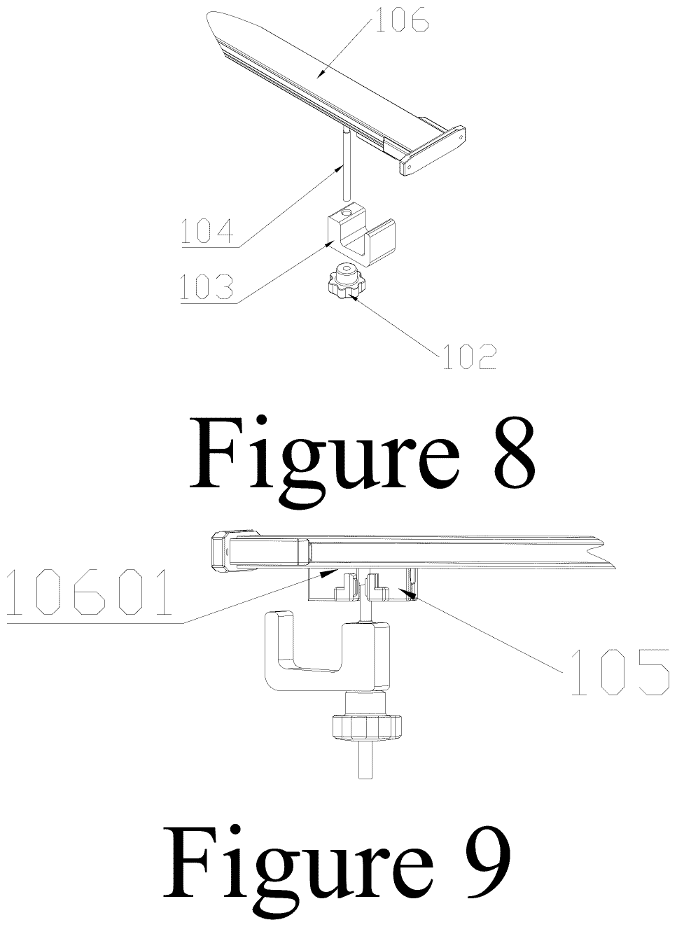

Based on embodiment 5, as shown in FIGS. 2, 3, 5-9, the waterproof tape (11) is provided at the lower side of the longitudinal support structure and is separated at the joint group.

The waterproof (11) is disposed between the car cover and the bucket to bridge the gap between the car cover and the compartment to improve the waterproofing effect.

The fourth support bar (10) comprises a intermediate bar (106), a slider (105), a T-bar (104), and a hook (103).

The slider (105) is connected to the intermediate bare (106), and it comprises a first slider slot (10502) and a second slider slot (10503), both of which are connected to each other.

The T-bar (104) comprises a bar head (10401) and a long T-bar (10402), the bar head (10401) extending through the first slider slot (10502) into the second slider slot (10503).

The hook (103) connected to the long T-bar (10402) is used to snap onto the edge of the vehicle body, while the long T-bar (10402) is connected to a plum nut (102).

The intermediate bar (106) is provided with an intermediate bar support surface (10601), and the bard head (10401) is sandwiched between the intermediate support surface and the slider protrusion (10501).

The fourth support bar (10) adopts a different connection structure, and since the fourth support bar (10) is connected to the front rail (1) and does not need to be easily opened, the stability of the connection is mainly considered. And in the locking state, the bar head (10401) is located in the second slider slot (10503), and the bottom of the bar head is tightened by the plum nut (102) for top tightening to realize the connection with the vehicle body, and when it is loosened, the T-bar (104) can be rotated to make the long T-bar (10402) snap into the first slider slot (10502) and rotate the T-bar long bar (10402) to a horizontal position.

### Specific Operation Principle:

When assembling, select the number of support bars and the number of joint groups for the car cover according to the need, and then connect the car cover frame, use the joint groups between the side rails (6) and the side rail (6) as the turning point for the car cover to be folded, and finally connect the tarpaulin to the car cover frame.

When installing, put the car cover on the top of the carrier, then use the hook assembly to connect the car cover, and then lock the plurality of support bars to the car body to complete the installation of the car cover.

The utility model is not limited to the above optional embodiments, and any person may arrive at various other forms of pbaructs under the inspiration of the utility model, but regardless of any changes in their shape or structure, all technical solutions falling within the scope defined by the claims of the utility model fall within the scope of protection of the utility model.

1. A soft car cover structure characterized in that: it comprises a front rail (1), a joint group, a rear rail (5), a side rail (6), a waterproof tape (11), a first support bar (7), a third support bar (9), and a fourth support bar (10), the first support bar (7), the third support bar (9), and the fourth support bar (10) are all connected to the side rails (6).
The front rail (1), the rear rail (5), the first support bar (7), the third support bar (9) and the fourth support bar (10) form a transverse support structure;
The side rails (6) and the joint group form a longitudinal support structure, the waterproof tapes (11) are connected to the longitudinal support structure, and two adjacent side rails (6) are connected to each other by the joint group, and the longitudinal support structure and the transverse support structure form a car cover frame connected to a piece of tarpaulin;
The first support bar (7) comprises a support bar body (75), a support bar T-bar (71) and a support bar slider (73), the support bar body (75) is connected to the side rails (6), the underside of the support bar body (75) is a support bar support surface (7501), the support bar slider (73) is connected to the support bare body (75), the support bar slider (73) is provided with a slider protrusion lock (7301) and an intermediate sliding groove (7302), the a slider protrusion lock (7301) is used to catch the T-shape support bar (71), when the long bar (7102) is caught with the slider protrusion lock (7301), the support bar T-bar (71) is located between the slider protrusion lock (7301) and the support bar support surface (7501), the support bar T-bar (71) includes a cylindrical head (7101),the cylindrical head (7101) extending into the intermediate sliding groove (7302).

2. The soft car cover structure according to claim 1, characterized in that: the first support bar (7) comprises a support bar slider insert (72) and a support bar wrench (74), the support bar wrench (74) is connected to the support bar T-bar (71), and the support bar slider insert (72) is connected to the support bar slider (73).

3. The soft car cover structure according to claim 2, characterized in that: the support bar T-bar (71) further comprises a long bar (7102) which is an integral structure together with the cylindrical head (7101), and the long bar (7102) is used to be pressed in under the slider protrusion lock (7301) to lock the long bar (7102).

4. The soft car cover structure according to claim 1, characterized in that: the joint group comprises a large joint group (2), a medium joint group (3) and a small joint group (4);Or the joint group comprises a large joint group (2) and a small joint group (4), the large joint group (2) and the small joint group (4) have a respective waterproof spacer (12), respectively, and further comprises a second support bar (8),the second support bar (8) is interposed between the first support bar (7) and the third support bar (9).

5. The soft car cover structure according to claim 1, characterized in that: the joint group comprises a left joint (31), an intermediate joint (32), a right joint (33), a first cavity (37) and a second cavity (38);
The left joint (31) has a left joint protrusion (3101), the intermediate joint (32) has an intermediate joint protrusion (3201) and a first cavity (37), and the right joint (33) has a second cavity (38), and the left joint protrusion (3101) uses a spring pin (34) to connected to the first cavity (37), and the intermediate joint protrusion (3201) uses a spring pin (34) to connected to the second cavity (38), and the spring pin (34) does not have a notch (3401).

6. The soft car cover structure according to claim 5, characterized in that the length of the intermediate joint protrusion (3201) is greater than that of the left joint protrusion (3101), and the depth of the first cavity (37) is less than that of the second cavity (38).

7. The soft car cover structure according to claim 6, characterized in that: it further comprises a first extruded spacer (35) and a second extruded spacer (36), the first extruded spacer (35) being used to be seated between the left connector protrusion (3101) and the first cavity (37), and the second extruded spacer (36) being used to be seated between the intermediate joint protrusion (3201) and the second cavity (38).

8. The soft car cover structure according to claim 1, characterized in that: the side rails (6) are connected to the vehicle body by an anti-detachment assembly (13),the anti-detachment assembly (13) comprises an upper hook (131), an anti-detachment T-bar (132), and a lower hook (134);
Wherein the upper hook (131) is attached to the side rail (6), and the upper hook (131) has a bayonet (13101);
The anti-disengagement T-shaped bar (132) passes through the lower hook (134). One end of the anti-disengagement T-shaped bar (132) is equipped with a locking port (13101) matched a square head (13201), and the other end of the anti-disengagement T-shaped bar (132) is connected to an anti-disengagement plum-shaped nut (133).

9. The soft car cover structure according to claim 4 is characterized by the fact that the waterproof gasket (12) comprises a left gasket (121), a middle gasket (122), and a right gasket (123), a waterproof surface is formed between the left gasket (121) and the middle gasket (122), a waterproof surface is formed between the middle gasket (122) and the right gasket (123), and the waterproof surface includes a concave surface (12201) and a convex surface (12101).

10. The soft car cover structure of claim 4, characterized in that, the fourth support bar (10) comprises an intermediate bar (106), a slider (105), a T-bar (104), and a hook (103);
The slider (105) is connected to the intermediate bare (106), and it comprises a first slider slot (10502) and a second slider slot (10503), both of which are connected to each other.
The T-bar (104) comprises a bar head (10401) and a long T-bar (10402), the bar head (10401) extending through the first slider slot (10502) into the second slider slot (10503);
The hook (103) connected to the long T-bar (10402) is used to snap onto the edge of the vehicle body, while the long T-bar (10402) is connected to a plum nut (102).
